(19) United States
(12) Patent Application Publication
(10) Pub. No.: US 2008/0130587 A1
(43) Pub. Date: Jun. 5, 2008

(54) Method for Automatically Setting a Frequency of a Base Station in a Cdma-2000 System

(75) Inventors: Ju Hyun Ban, Daegu (KR); San Won Son, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom Korea Limited

(21) Appl. No.: 10/561,351

(22) PCT Filed: Jul. 23, 2004
(86) PCT No.: PCT/KR04/01854

§ 371 Date: Dec. 4, 2007

(30) Foreign Application Priority Data
Jul. 24, 2003 (KR) 10-2003-0051154

(51) Int. Cl. H04B 7/216

(52) U.S. Cl. 370/335

(57) ABSTRACT

The present invention is directed to a method for automatically setting a frequency of a base station in a CDMA-2000 system, comprising: defining a frequency configuration information in a Programmable Loading Data (PLD) that defines different frequency bands for respective service providers; reading the frequency configuration information from the PLD defining the frequency configuration information when the base station is initialized and transmitting it to a Block of RF control (BRFC); and automatically setting the frequency of the base station on the basis of the frequency configuration information. The method for automatically setting a frequency of a base station in a CDMA-2000 system according to the present invention comprises: requesting RF configuration data from the BRFC to the BDCC when the base station is initialized; requesting RF configuration data from the BDCC to the BBSM; upon receiving the request for RF configuration data by the BBSM, reading a frequency configuration information from a PLD, which defines the frequency configuration information; transmitting the frequency configuration information to the BRFC via the BDCC; and setting the frequency of the base station on the basis of the frequency configuration information transmitted from the BRFC.

### TECHNICAL FIELD

The present invention generally relates to a method for automatically setting a frequency of a base station in a CDMA-2000 1x system, and particularly to a method for automatically setting a frequency in a CDMA-2000 system wherein a certain desired frequency band is automatically set for each service provider.

More particularly, the present invention is directed to a method for automatically setting a frequency of a base station in a CDMA-2000 system, comprising: defining a frequency configuration information in a Programmable Loading Data (PLD) that defines different frequency bands for respective service providers; reading the frequency configuration information from the PLD defining the frequency configuration information when the base station is initialized and transmitting such information to a Block of RF control (BRFC); and automatically setting the frequency of the base station on the basis of the frequency configuration information.

### BACKGROUND ART

In general, each service provider in Korea or other countries uses a different frequency band (e.g., 800 MHz, 1.8 GHz, 1.9 GHz, 450 MHz, etc.) in a CDMA-2000 1x system. Thus, the frequency bands used by various service providers are different from each other.

Conventionally, since each service provider uses a different frequency band, a package for each service provider was manufactured. Further, Blocks of Base Station Status Management (BBSMs) were provided for those packages, wherein the frequency was set with different frequency configuration information

### DISCLOSURE OF INVENTION

### Technical Problem

The conventional structure, as defined above, often made it difficult to optimally manage the BBSM that sets frequency for various providers each having a different frequency band. There was always a likelihood that the manufactured packages may cause some problems in the frequency setting for each provider.

It is, therefore, an object of the present invention to address and resolve such problems associated with said conventional structure where the packages were manufactured for respective service providers and different BBSMs were prepared for each package.

### Technical Solution

The object of the present invention is to provide a method for automatically setting a frequency of a base station in a CDMA-2000 system wherein a suitable frequency band is automatically set for each service provider.

In particular, the object of the present invention is to provide a method for automatically setting a frequency of a base station in a CDMA-2000 system, comprising: defining a frequency configuration information in a Programmable Loading Data (PLD) that defines different frequency bands for respective service providers; reading the frequency configuration information from the PLD defining the frequency configuration information when the base station is initialized and transmitting such information to a Block of RF control (BRFC); and automatically setting the frequency of the base station on the basis of the frequency configuration information.

According to one embodiment of the present invention which achieves said object, there is provided a method for automatically setting a frequency of a base station in a CDMA-2000 system, wherein the system comprises: a Block of Base station Status Management (BBSM) for managing the status of the base station; a Block of Digital unit Control and management (BDCC) for controlling and managing digital units; and a Block of RF Control (BRFC) for automatically setting a RF frequency. The method comprises the flowing steps of: requesting RF configuration data from the BRFC to the BDCC when the base station is initialized; requesting RF configuration data from the BDCC to the BBSM; upon receiving the request for RF configuration data by the BBSM, reading a frequency configuration information from a PLD, which defines frequency configuration information; transmitting the frequency configuration information to the BRFC via the BDCC; and setting the frequency of the base station on the basis of the frequency configuration information transmitted from the BRFC.

According to another embodiment of the present invention which achieves said object, there is provided a method for automatically setting a frequency of a base station in a CDMA-2000 system, wherein the system comprises: a BBSM for managing the status of the base station; a BDCC for controlling and managing digital units; and a BRFC for automatically setting a RF frequency. The method comprises the following steps of: if an operator requests changing a RF configuration data, reading by the BBSM a frequency configuration information from a PLD that defines the frequency configuration information and transmitting the frequency configuration information to the BDCC; transmitting the RF configuration data from the BDCC to BRFC; and setting the frequency of the base station on the basis of the frequency configuration information received in the BRFC.

### BRIEF DESCRIPTION OF THE DRAWINGS

These drawings depict only the preferred embodiments of the present invention and should not be considered as limitations of its scope. These as well as other features of the present invention will become more apparent upon reference to the drawings in which:

FIG. 1 illustrates a signal flow showing the automatic setting of a frequency of a base station in a CDMA-2000 system according to the present invention.

FIG. 2 illustrates a flow chart showing the RF information process in a BBSM for the method of automatically setting a frequency of a base station in a CDMA-2000 system according to the present invention.

FIG. 3 illustrates a flow chart showing the transmission and reception of a signal in a BDCC for the method of automatically setting a frequency of a base station in a CDMA-2000 system according to the present invention.

FIG. 4 illustrates a flow chart showing the automatic setting of a RF frequency in a BRFC for the method of automatically setting a frequency of a base station in a CDMA-2000 system according to the present invention.

### BEST MODE FOR CARRYING OUT THE INVENTION

The preferred embodiments of the present invention will be described in detail with reference to the attached drawings.

In a preferred embodiment of the present invention, when BBSM is requested of RF configuration data from a BRFC via a BDCC or the frequency of a base station is changed by the request of an operator at the initialization of the base station, the BBSM reads a PLD relating to the frequency of the base station and transmits it to the BRFC. The BRFC receives a frequency configuration information and sets the frequency of the base station.

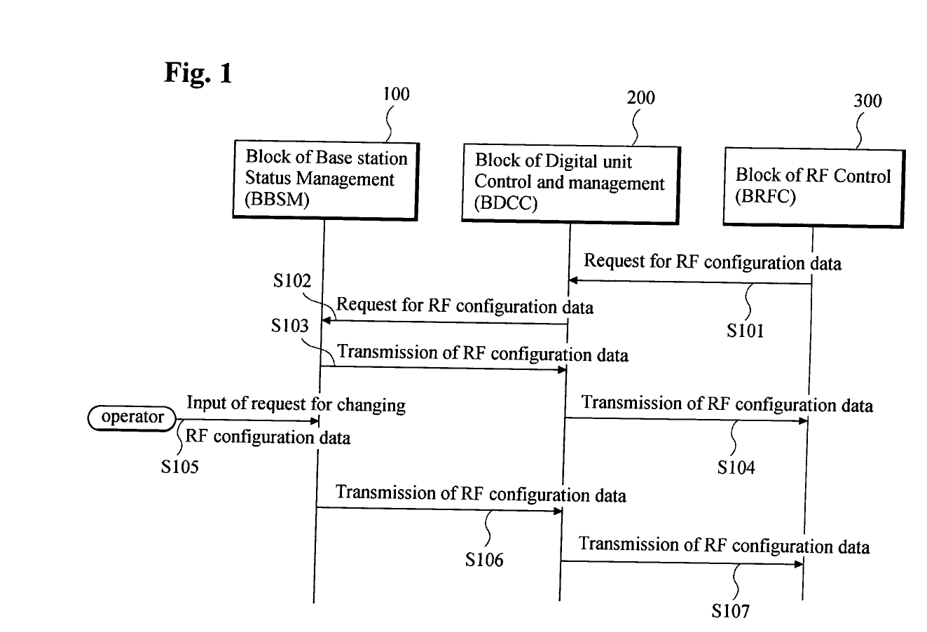

FIG. 1 illustrates a signal flow diagram showing the automatic setting of a frequency of a base station in a CDMA-2000 system according to the present invention.

In FIG. 1, reference numeral 100 indicates a Block of Base station Status Management (BBSM) that manages the base station status. Reference numeral 200 denotes a Block of Digital unit Control and management (BDCC) that controls and manages a digital unit. Reference numeral 300 denotes a Block of RF Control (BRFC) that automatically sets RF frequency.

As shown in FIG. 1, at Step S101, the BRFC 300 requests a RF configuration data to the BDCC 200 when a base station is initialized. At Step 102, the BDCC 200 requests the RF configuration data to the BBSM 100.

When requested of the RF configuration data, then at Step S103, the BBSM 100 reads frequency configuration information (e.g., RF frequency interval value and RF frequency) in a PLD that defines the frequency configuration information and transmits it to the BDCC 200.

An Step 104, the BDCC 200 transmits the RF configuration information received from the BBSM 100. Then, the BRFC 200 sets a frequency of the base station on the basis of the frequency configuration information.

If an operator requests changing the RF configuration data at Step 105, then at Step 106, the BBSM 100 reads the frequency configuration information from the PLD that defines the frequency configuration information and transmits it to the BDCC 200.

Subsequently, at Step S107, the BDCC 200 transmits the RF configuration data to the BRFC 300 and the BRFC 300 sets the frequency of the base station on the basis of the frequency configuration information.

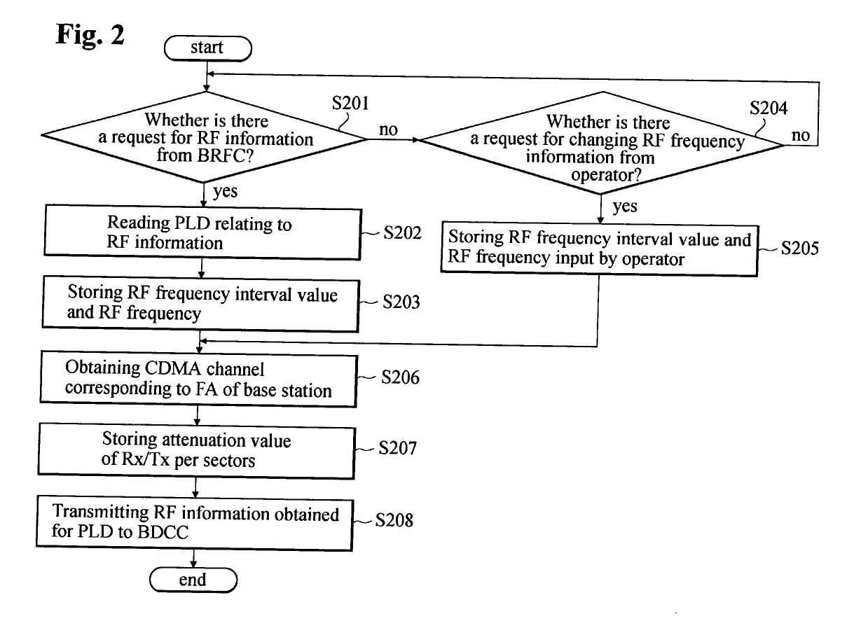

FIG. 2 is a flow chart illustrating the RF information process in a BBSM for the method of automatically setting a frequency of a base station in a CDMA-2000 system according to the present invention.

As shown in FIG. 2, the procedure of RF information process in a BBSM according to the present invention comprises the following steps of: checking whether the BRFC 300 requests the RF information (S201); if there is a request for the RF information, reading the RF-related PLD (S202); extracting RF frequency interval value and RF frequency from the PLD and storing them (S203); if there is no request for the RF information at Step S201, checking whether there is a request from an operator for changing the RF frequency information (S204); if there is a request for changing the RF frequency information in S204, storing the RF frequency interval value and RF frequency input by the operator (S205); Subsequent to Steps S203 and S205, obtaining a CDMA channel according to the FA of the base station (S206); storing the attenuation value of receipt (Rx)/transmission (Tx) per sectors (S207); and transmitting the RF information obtained from the PLS to the BDCC 200 (S208).

More detailed description on the procedure of the RF information process in the BBSM will be provided below.

First, the BBSM 100 checks whether the BRFC 300 generates a request for the RF information in S201. If the BRFC 300 generates a request for the RF information, then it reads the PLS relating to the RF information in S202. At Step 203, the BBSM 100 extracts the RF frequency interval value and RF frequency from the PLD and stores them.

If there is no request for the RF information in S201, then at Step S204, it is checked whether there is a request from an operator for changing the RF frequency information. If there is no request for changing the RF frequency information, then the process goes back to the first step. However, if there is a request from an operator for changing the RF frequency information, then at Step 205, the RF frequency interval value and RF frequency that the operator inputs are stored. In this step, the RF frequency interval value and RF frequency are stored just in case they are within the predetermined ranges. If they are not within the predetermined ranges, then an error signal is outputted and the procedure for automatically setting the frequency is finished.

Subsequent to Steps S203 and S205, CDMA channel depending on FA of a base station is obtained at Step S206. At Step S207, the attenuation values of receipt (Rx)/transmission (Tx) per sectors are stored. At Step S208, the RF information obtained from the PLD is transmitted to the BDCC 200.

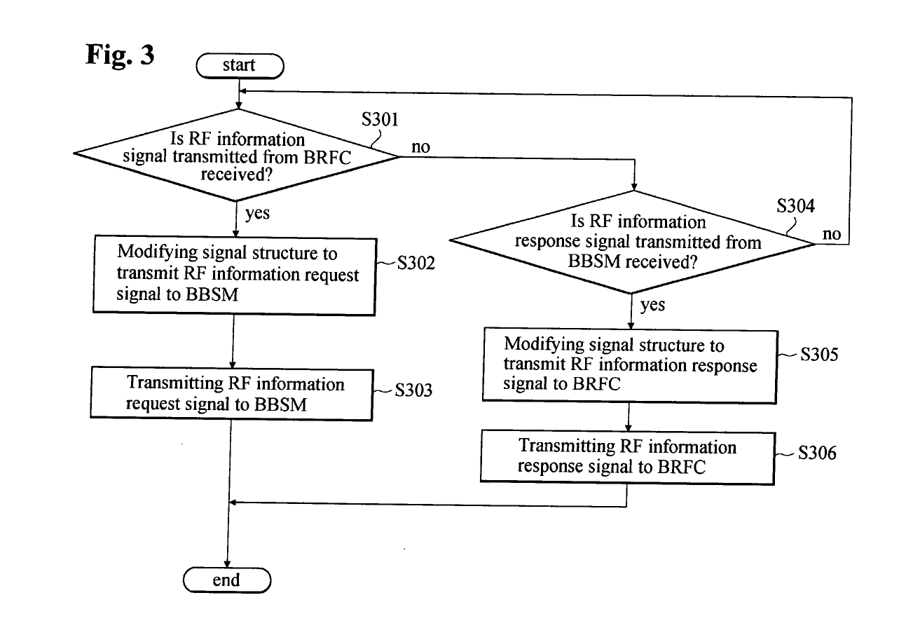

FIG. 3 is a flow chart illustrating the transmission and reception of a signal in a BDCC for the method of automatically setting a frequency of a base station in a CDMA-2000 system according to the present invention.

As shown in FIG. 3, the procedure of transmitting and receiving signal in a BDCC according to the present invention comprises the following steps of: checking whether the RF information request signal that the BRFC 300 transmits is received (S301); if the RF information request signal that the BRFC 300 transmits is received, modifying the signal structure to transmit the RF information request signal to the BBSM 100 (S302); transmitting the modified RF information request signal to the BBSM 100 (S303); if the RF information request signal transmitted from the BRFC 300 is not received at Step S310, checking whether the RF information response signal transmitted from the BBSM is received (S304); if the RF information response signal is received at Step S304, modifying the signal structure to transmit the RF information response signal to the BRFC 300 (S305); and transmitting the modified RF information response signal to the BRFC 300 (S306).

More detailed description on the procedure of the RF information process in the BBSM will be provided below.

At Step S301, the BDCC 200 checks whether the RF information request signal transmitted from the BRFC 300 is received. If the RF information request signal transmitted from the BRFC 300 is received, then at Step S302, the signal structure is modified to transmit the RF information request signal to the BBSM 100. At Step S303, the modified RF information request signal is transmitted to the BBSM 100. However, if the RF information request signal transmitted from the BRFC 300 is not received at Step S301, then at Step S304, it is checked whether the RF information response signal transmitted from the BBSM 100 is received. If the RF information response signal is received, then at Step S305, the signal structure is modified to transmit the RF information response signal to the BRFC 300. Subsequently, at Step S306, the modified RF information response signal is transmitted to the BRFC 300.

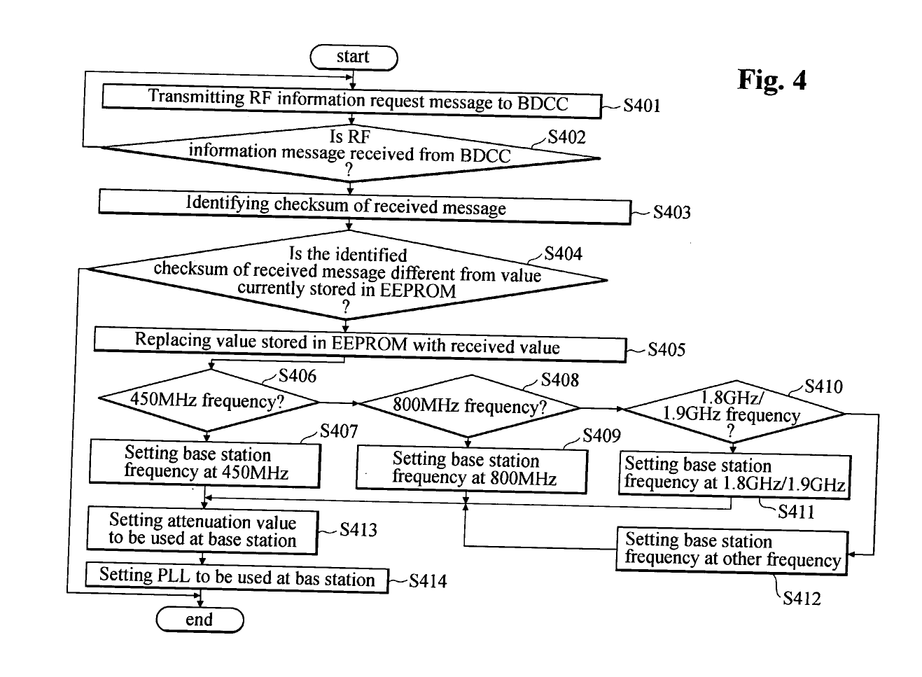

FIG. 4 is a flow chart illustrating the procedure of setting a RF frequency in a BRFC for the method of automatically setting a frequency of a base station in a CDMA-2000 system according to the present invention.

As shown in FIG. 4, the procedure of setting a RF frequency in a BRFC according to the present invention comprises the following steps of: transmitting a RF information request message to BDCC 200 (S401); checking whether the RF information message is received from the BDCC 200 (S402); if the RF information message is received, identifying the checksum of the received message (S403); determining whether said identified checksum is different from a value currently stored in a EEPROM (S404); if the identified checksum is identical to the value currently stored in the EEPROM, finishing the procedure of setting the frequency; if the checksum is different from the value currently stored in the EEPROM, replacing the value stored in the EEPROM with the received value (S405) and storing the received value; setting the frequency of the base station corresponding to the updated value stored in the EEPROM (S406-S412); setting an attenuation value to be used at the base station after the frequency setting of the base station (S413); and setting a PLL to be used at the base station (S414).

More detailed description on the procedure of setting a RF frequency in the BRFC will be provided below.

At Step S401, the BRFC 300 transmits the RF information request message to BDCC 200. At Step S402, it is checked whether the RF information message on the RF information request is received from the BDCC 200. If the RF information message is received, then at Step S403, the checksum of the received message is identified. At Step S404, it is determined whether the identified checksum is different from the value currently stored in an EEPROM. If the identified checksum is identical to the value currently stored in the EEPROM, the procedure of setting the frequency is finished. However, if the identified checksum is different from the value currently stored in the EEPROM, then at Step S405, the value stored in the EEPROM is replaced by the received value and the received value is stored in the EEPROM. At Steps S406-412, the frequency of the base station is set correspondingly to the updated value stored in the EEPROM. In other words, when the value stored in the EEPROM is 450 MHz (S406), the frequency of the base station is set as 450 MHz, at Step S407. When the value stored in the EEPROM is 800 MHz (S408), the frequency of the base station is set as 800 MHz at Step S409. When the value stored in the EEPROM is 1.8 GHz/19 GHz (S410), the frequency of the base station is set as 1.8 GHz/1.9 GHz at Step S411. Further, if the value stored in the EEPROM is different from said frequency values, the stored value is set as the frequency of the base station.

After the frequency of the base station is set at Step 413, attenuation values of receipt/transmission (Rx/Tx) to be used at the base station is obtained and set from the received message information. At Step S414, a PLL to be used at the base station is obtained and set from the received message information.

### INDUSTRIAL APPLICABILITY

In the present invention, different frequency configuration information is defined for each service provider in a PLD. Further, the frequency configuration information read from the PLD when a base station is initialized and is transmitted to a BRFC, in which the frequency of the base station is set thereby. As such, the possibility of error in manufacturing packages for respective service providers may be eliminated and easier management of the Block of Base station Status Management may be provided, thereby improving the stability and reliability of the system.

1. A method for automatically setting a frequency of a base station in a CDMA-2000 system, the system comprising a Block of Base station Status Management (BBSM) for managing the status of the base station, a Block of Digital unit Control and management (BDCC) for controlling and managing digital units and a Block of RF Control (BRFC) for automatically setting a RF frequency, said method comprising the steps of:
requesting RF configuration data from the BRFC to the BDCC when the base station is initialized;
requesting RF configuration data from the BDCC to the BBSM;
upon receiving the request for RF configuration data by the BBSM, reading a frequency configuration information from a PLD, which defines the frequency configuration information;
transmitting the frequency configuration information to the BRFC via the BDCC; and
setting the frequency of the base station on the basis of the frequency configuration information transmitted from the BRFC

2. The method of claim 1, wherein the BBSM performs the operations comprising the steps of:
checking whether an initial RF information request is generated from the BRFC;
as a result of said checking, if the initial RF information request is generated, reading a RF-related PLD;
extracting a RF frequency interval value and RF frequency from the read PLD and storing them;
as a result of said checking, if the initial RF information request is not generated, identifying whether there is a request for changing a RF frequency information;
as a result of said identifying, if there is the request for changing the RF frequency information, storing the RF frequency interval value and the RF frequency that an operator inputs;
obtaining a CDMA channel depending on a FA of the base station after the RF frequency is stored;
storing attenuation vales of receipt (Rx)/transmission (Tx) per sectors; and
transmitting the RF information obtained from the PLD to the BDCC.

3. The method of claim 1, wherein the BDCC performs the operations comprising the steps of:
checking whether a RF information request signal transmitted from the BRFC is received;
as a result of said checking, if the RF information request signal transmitted from the BRFC is received, modifying the signal structure of the RF information request signal to transmit the RF information request signal to the BBSM;
transmitting the modified RF information request signal to the BUM;
as a result of said checking, if the RF information request signal is not generated from the BRFC, determining whether a RF information response signal transmitted from the BBSM is received;
as a result of said determining, if the RF information response signal is received, modifying the signal structure of the RF information response signal to transmit the RF information response signal to the BRFC; and
transmitting the modified RF information response signal to the BRFC;

4. The method of claim 1, wherein the BRFC performs the operations comprising the steps of:
transmitting a RF information request message to the BDCC;
checking whether a RF information message is received from the BDCC;
as a result of said checking, if the RF information message is received, identifying a checksum of the received message;
determining whether the identified checksum is different from a value currently stored in an EEPROM;
if the identified checksum is identical to the value currently stored in the EEPROM, finishing the operations for automatically setting a frequency of a base station;
if the identified checksum is different from the value currently stored in the EEPROM, replacing the vale stored in the EEPROM with the received value and storing the received vale in the EEPROM;
setting the frequency of the base station correspondently to the replaced and stored vale;
setting attenuation values to be used at the base station after the frequency of the base station is set; and
setting a PLL to be used in the base station.

5. A method for automatically setting a frequency of a base station in a CDMA-2000 system, the system comprising a BBSM for managing the status of the base station, a BDCC for controlling and managing digital units and a BRFC for automatically setting a RF frequency, said method comprising the steps of:
if an operator requests changing a RF configuration data, reading by the BBSM a frequency configuration information from a PLD that defines the frequency configuration information and transmitting the frequency configuration information to the BDCC;
transmitting the RF configuration data from the BDCC to BRFC; and
setting the frequency of the base station on the basis of the frequency configuration information received in the BRFC.
